(19) United States
(12) Patent Application Publication
(10) Pub. No.: US 2012/0170078 A1
(43) Pub. Date: Jul. 5, 2012

(54) IMAGE PROCESSING SYSTEM AND METHOD

(75) Inventor: TENG-YU TSAI, Tu-Cheng (TW)

(73) Assignee: HON HAI PRECISION INDUSTRY CO., LTD., Tu-Cheng (TW)

(21) Appl. No.: 13/210,561

(22) Filed: Aug. 16, 2011

(30) Foreign Application Priority Data
Dec. 31, 2010 (TW) 99147408

(51) Int. Cl. G06K 15/02

(52) U.S. Cl. 358/1.18

(57) ABSTRACT

An image processing system includes an image obtaining module, a template retrieving module, a template applying module, and an image generating module. The image obtaining module obtains a plurality of original images from one or more sources. The template retrieving module retrieves a layout template that defines a plurality of layout frames in a presentation. The template applying module arranges the plurality of original images in the plurality of layout frames. The image generating module generates a new image based on the plurality of layout frames in which the plurality of original images is arranged.

### BACKGROUND

1. Technical Field

The disclosure generally relates to an image processing system and an image processing method.

2. Description of Related Art

In an image processing system, a user can manipulate images such as cropping, rotation, and color correction, prior to printing. If only one image is printed on a single piece of paper, there could be waste if the size of the image is not large enough to fill up a sheet. Therefore, there is a need to print multiple images in a single sheet. However, it is inconvenient for the user to create and arrange a print layout when the user wants to print multiple images on a single piece of paper. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a schematic diagram of one embodiment of an electronic device suitable for use in implementing an image processing system.

FIG. 2 is a schematic diagram of one embodiment of the function modules of the image processing system of FIG. 1.

FIG. 3 illustrates a view of a graphic user interface for selecting a layout template from a list of candidate layout templates in one embodiment.

FIG. 4 is an operational flow diagram representing one embodiment of a method for processing images using the processing system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

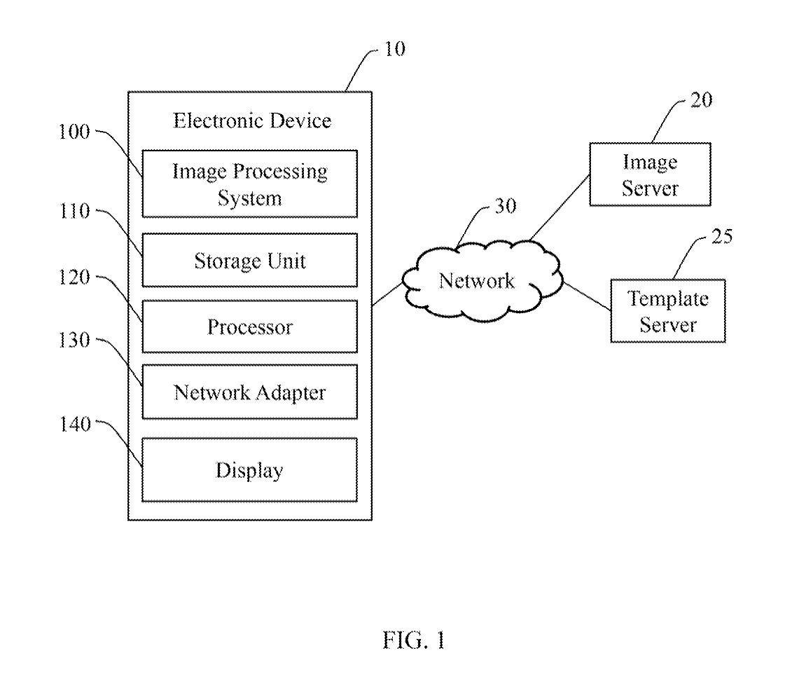

FIG. 1 is a schematic diagram of one embodiment of an electronic device 10. In the embodiment, the electronic device 10 includes an image processing system 100, a storage unit 110, at least one processor 120, a network adapter 130, and a display 140. The electronic device 10 implements the functions of the image processing system 100. The electronic device 10 can be a general purpose computing device such as a desktop computer, a tablet computer, a personal digital assistant (PDA), or a smart phone. The storage unit 110 can be a magnetic or an optical storage device, such as a hard disk drive, an optical drive, or a tape drive. The storage unit 110 can store images. The display 140 can be a liquid crystal display (LCD) or a cathode-ray tube (CRT) display.

With reference with FIG. 1, the electronic device 10 can operate in a network 30 which provides logical connections to one or more remote computers, such as an image server 20 and a template server 25. The network 30 may be a local area network (LAN) or a wide area network (WAN), such as the Internet. The electronic device 10 is connected to the network 30 through the network adapter 130. The network adapter 130 may be a network interface card using a specific physical layer and a data link layer standard such as Ethernet or Wi-Fi.

The image server 20 may store a plurality of images and provide images to the image processing system 100 in a variety of protocols. A uniform resource locator (URL) can be used to specify the location of an image. For example, a URL “http://d1.flickr.cc/starjpg” can specify an image file named “star.jpg” located in a HTTP server whose domain name is “dl.flickr.cc” in the HTTP protocol.

The template server 20 may store a plurality of layout templates. A layout template may define a plurality of layout frames in a presentation. Each of the layout frames is associated with information of size and position in the presentation. The size of a layout frame can be determined by a width and a height, for example 400×600 pixels. The position of a layout frame may be identified by a set of coordinates such as coordinates of the four corners of a rectangle in the presentation. An image can be arranged in each of the plurality of layout frames.

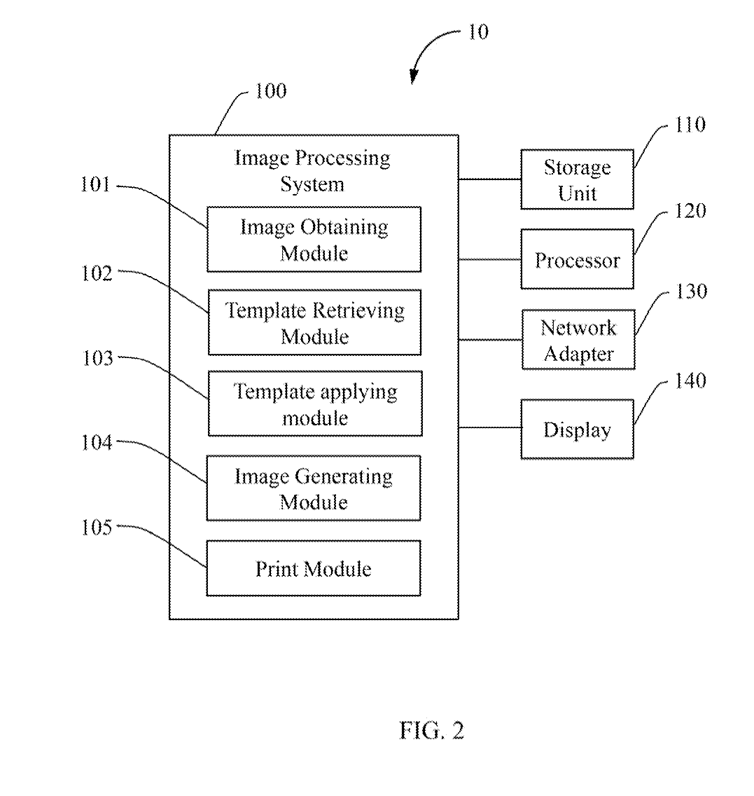

FIG. 2 is a schematic diagram of one embodiment of the function modules of the image processing system 100. In the embodiment, the image processing system 100 includes an image obtaining module 101, a template retrieving module 102, a template applying module 103, an image generating module 104, and a print module 105. Each of the modules 101-105 may be a software program including one or more computerized instructions that are stored in the storage unit 110 and executed by the processor 120.

The image obtaining module 101 may obtain a plurality of original images from one or more sources. The original images can be loaded from a local source such as a file folder in the storage unit 110, for example, “X: \photos\”. The image obtaining module 101 may also obtain original images from a remote source such as in the image server 20. The original images may be in a variety of supported formats such as JPEG, GIF, PNG, TIFF, and Bitmap.

The template retrieving module 102 may download a list of candidate layout templates from the template server 25 via the network 30 and store the list of candidate layout templates in the storage unit 110. The template retrieving module 102 may display the list of candidate layout templates on the display 140. A user can select a layout template from the list of candidate layout templates.

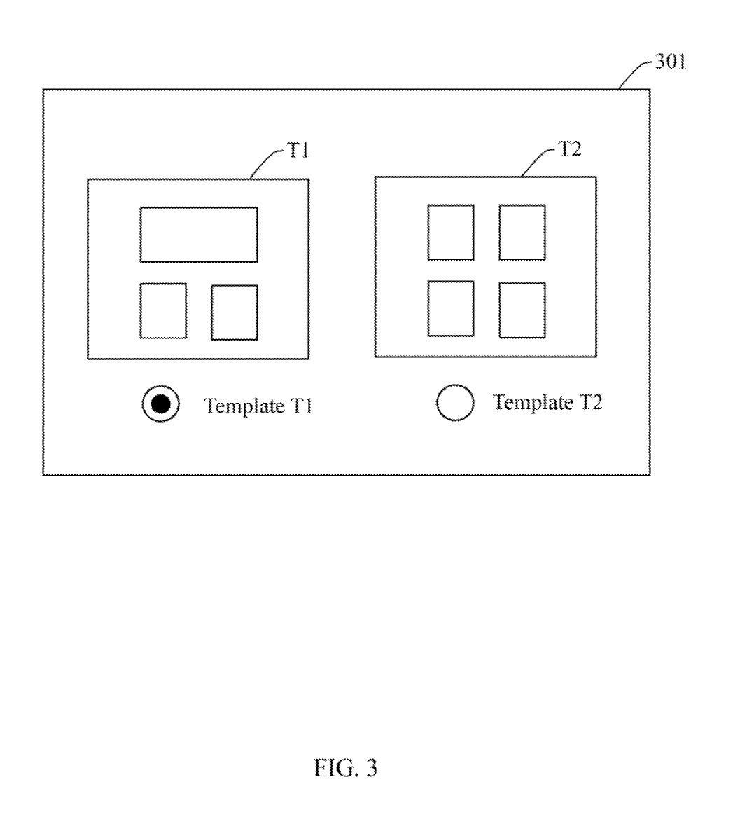

FIG. 3 illustrates a view of a graphic user interface (GUI) 301 for selecting a layout template from a list of candidate layout templates. In the GUI 301, the previews of two candidate layout templates T1 and T2 are presented. The layout template T1 defines three layout frames and the layout template T2 defines four layout frames as shown in FIG. 3. The user can select one of them by clicking the corresponding radio box. For example, according to FIG. 3 the user selects the layout template T1.

When a layout template is selected, the template applying module 103 may arrange the original images in the layout frames of the selected layout template. If the total number of the original images obtained by the image obtaining module 101 is greater than the number of the layout frames of the selected layout template, the template applying module 103 may obtain the same number of original images as the number of the layout frames of the selected layout template, and subsequently arrange the same number of the original images in the layout frames of the selected layout template.

The image generating module 104 may generate a new image based on the layout frames of the selected layout template, in which the same number of the original images as the number of the layout frame are arranged. As a result, the new image can be stored in the storage unit 110 or transmitted to the print module 105.

The print module 105 may print the new image when receiving the new image. In addition, the print module 105 may apply a special effect to the new image before printing it.

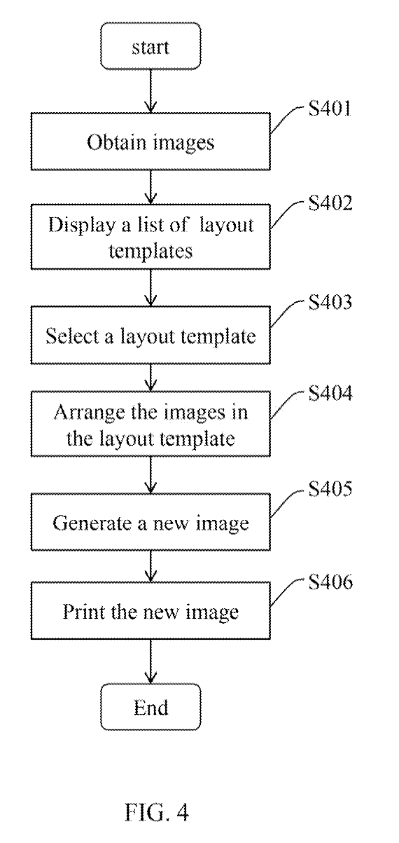

FIG. 4 is a flowchart illustrating one embodiment of a method for processing image using the image processing system of FIG. 1. The method may include the following steps.

In step S401, the image obtaining module 101 obtains a plurality of original images from one or more sources.

In step S402, the template retrieving module 102 displays a list of candidate layout templates on the display 140. In one embodiment, the list of candidate layout templates can be obtained from the storage unit 110 directly. In another embodiment, the list of candidate layout templates can be downloaded form the template server 25 via the network 30 and then provided to the template retrieving module 102.

In step S403, the template retrieving module 102 selects a layout template from the list of candidate layout templates according to a selection of the user on a GUI.

In step S404, the template applying module 103 applies the same number of original images as the number of the layout frames of the selected layout template in the layout frames of the selected layout template.

In step S405, the image generating module 104 generates a new image based on the layout frames of the selected layout template, in which the same number of original images as the number of the layout frame are arranged.

In step S406, the print module 105 prints the new image.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

Depending on the embodiment, certain steps or methods described may be removed, others may be added, and the sequence of steps may be altered. It is also to be understood that the description and the claims drawn for or in relation to a method may include some indication in reference to certain steps. However, any indication used is only to be viewed for identification purposes and not as a suggestion as to an order for the steps.

What is claimed is:

1. A computer-implemented method for processing images in an electronic device, the method comprising:
obtaining a plurality of original images from one or more sources;
retrieving a layout template that defines a plurality of layout frames in a presentation;
arranging the plurality of original images in the plurality of layout frames; and
generating a new image based on the plurality of layout frames in which the plurality of original images is arranged.

2. The method of claim 1, wherein the one or more sources comprise a storage unit of the electronic device.

3. The method of claim 1, wherein the one or more sources comprise an image server accessible to the electronic device via a network.

4. The method of claim 1, wherein the number of the plurality of original images is the same as the number of the plurality of layout frames.

5. The method of claim 1, further comprising selecting the layout template from a list of candidate layout templates.

6. The method of claim 5, further comprising downloading the list of candidate layout templates from a template server, the template server being accessible to the electronic device via a network.

7. The method of claim 5, further comprising displaying the list of candidate layout templates on a display of the electronic device.

8. The method of claim 1, wherein each of the plurality of layout frames is associated with size and position information in the presentation.

9. The method of claim 1, wherein the layout template is stored in an XML file.

10. The method of claim 1, further comprising printing the new image.

11. A system for processing images in an electronic device, the system comprising:
an image obtaining module adapted to obtain a plurality of original images from one or more sources;
a template retrieving module adapted to retrieve a layout template that defines a plurality of layout frames in a presentation;
a template applying module adapted to arrange the plurality of original images in the plurality of layout frames; and
an image generating module adapted to generate a new image based on the plurality of layout frames in which the plurality of original images is arranged.

12. The system of claim 11, wherein the one or more sources comprise a storage unit of the electronic device.

13. The system of claim 11, wherein the one or more sources comprise an image server, the remote server being accessible to the electronic device via a network.

14. The system of claim 11, wherein the number of the plurality of original images is the same as the number of the plurality of layout frames.

15. The system of claim 11, wherein the template retrieving module is further adapted to select the layout template from a list of candidate layout templates.

16. The system of claim 15, wherein the template retrieving module is further adapted to download the list of candidate layout templates from a template server accessible to the electronic device via a network.

17. The system of claim 15, wherein the template retrieving module is further adapted to display the list of candidate layout templates on a display of the electronic device.

18. The system of claim 11, wherein each of the plurality of layout frames is associated with size and position information in the presentation.

19. The system of claim 11, further comprising a print module adapted to print the new image.

20. A computer-implemented method for processing images in an electronic device, the method comprising:
providing an image obtaining module, a template retrieving module, a template applying module, and an image generating module;
obtaining a plurality of original images from one or more sources by the image obtaining module;
retrieving a layout template that defines a plurality of layout frames in a presentation by the template retrieving module;
arranging the plurality of original images in the plurality of layout frames by the template applying module; and
generating a new image by the image generating module based on the plurality of layout frames in which the plurality of original images is arranged.
